(19) United States
(12) Patent Application Publication
(10) Pub. No.: US 2022/0064401 A1
(43) Pub. Date: Mar. 3, 2022

(54) STRETCH-FORMED PRODUCT

(71) Applicant: NEC Corporation, Minato-ku, Tokyo (JP)

(72) Inventors: Tomo TANAKA, Tokyo (JP); Ryota YUGE, Tokyo (JP)

(73) Assignee: NEC Corporation, Minato-ku, Tokyo (JP)

(21) Appl. No.: 17/424,108

(22) PCT Filed: Jan. 20, 2020
(86) PCT No.: PCT/JP2020/001713

§ 371 Date: Jul. 19, 2021

(30) Foreign Application Priority Data
Jan. 21, 2019 (JP) 2019-007685

(51) Int. Cl. C08K 3/04; C08J 5/18; C08J 3/20; D01F 1/09

(52) U.S. Cl. CPC C08K 3/044; C08J 5/18; C08J 2367/02; D01F 1/09; C08K 2201/011; C08J 3/203

(57) ABSTRACT

It is an object of the present invention to provide a stretch-formed product having a high conductivity. A stretch-formed product of the present embodiment includes a fibrous carbon nanohorn aggregate in which single-walled carbon nanohorns are radially aggregated and fibrously connected, and a resin.

### TECHNICAL FIELD

The present invention relates to a stretch-formed product and a method for producing the same.

### BACKGROUND ART

Conductive resins containing conductive materials are processed into fibers, films and the like, and used in various fields. Patent Literature 1 describes a conductive multi-fiber used in optogenetics controlling brain firing.

### CITATION LIST

### Patent Literature

Patent Literature 1: U.S. Pat. No. 9,861,810

### SUMMARY OF INVENTION

### Technical Problem

Although the diameter of the multi-fiber used in optogenetics described in Patent Literature 1 is about 200 μm, for suppressing invasiveness, development of a multi-fiber having a small diameter is anticipated. In order to make the diameter small, an improvement in the conductivity of the multi-fiber is needed. Resins using conventional conductive materials, however, have such a problem that when the resins are stretched, conductive paths are cut, lowering the conductivity. The present invention, in consideration of such a problem, has an object to provide a stretch-formed product having a high conductivity.

### Solution to Problem

A stretch-formed product of the present embodiment comprises a fibrous carbon nanohorn aggregate in which single-walled carbon nanohorns are radially aggregated and fibrously connected, and a resin.

### Advantageous Effect of Invention

According to the present invention, a stretch-formed product having a high conductivity can be provided.

### BRIEF DESCRIPTION OF DRAWING

FIG. 1 is photographs of a stretch-formed product containing fibrous carbon nanohorn aggregates (lower) and an unstretch-formed product used for production of the same (upper).

### DESCRIPTION OF EMBODIMENTS

A stretch-formed product according to the present embodiment contains fibrous carbon nanohorn aggregates. The fibrous carbon nanohorn aggregate is called also a carbon nanobrush (CNB), and has a structure in which single-walled carbon nanohorns are radially aggregated and fibrously connected. The fibrous carbon nanohorn aggregate is different from a material in which a plurality of single-walled carbon nanohorns simply range and which looks fibrous, and can retain the fibrous shape even when being subjected to an operation such as centrifugation or ultrasonic dispersion. The single-walled carbon nanohorn is a conical-shape carbon structural body, in which a graphene sheet is rolled, of 1 nm to 5 nm in diameter and 30 nm to 100 nm in length whose tip is hornily sharpened to a tip angle of about 20°. Here, the carbon structural body is a structural body containing mainly carbon, and may contain light elements and catalytic metals. The fibrous carbon nanohorn aggregate is a fibrous carbon structural body, and usually has a diameter of 30 nm to 200 nm, and a length of 1 μm to 100 μm, for example, 2 μm to 30 μm. The fibrous carbon nanohorn aggregate usually has an aspect ratio (length/diameter) of 4 to 4,000, and for example, 5 to 3,500. The surface of the fibrous carbon nanohorn aggregate has protrusions of single-walled carbon nanohorns of 1 nm to 5 nm in diameter and 30 nm to 100 nm in length. The fibrous carbon nanohorn aggregate has a high conductivity since its structure is characterized by single-walled carbon nanohorns having a high conductivity and fibrously connected, and having long conductive paths. The fibrous carbon nanohorn aggregate further concurrently has high dispersibility and has a large effect of imparting conductivity.

The fibrous carbon nanohorn aggregate is usually formed by seed-type, bud-type, dahlia-type, petal dahlia-type or petal-type (graphene sheet structure) carbon nanohorn aggregates being connected. That is, the fibrous carbon nanohorn aggregate contains one type or plural types of these carbon nanohorn aggregates in the fibrous structure. The seed-type has such a shape that the surface of the aggregate has few or no horny protrusions; the bud-type has such a shape that the surface of the aggregate has a few horny protrusions; the dahlia-type has such a shape that the surface of the aggregate has a large number of horny protrusions; and the petal-type has such a shape that the surface of the aggregate has petal-like protrusions. The petal structure is a structure of 2 to 30 sheets of graphene of 50 nm to 200 nm in width and 0.34 nm to 10 nm in thickness. The petal dahlia-type is a structure intermediate between the dahlia-type and the petal-type. The carbon nanohorn aggregate to be produced varies in the form and the particle diameter depending on the kind and the flow rate of a gas.

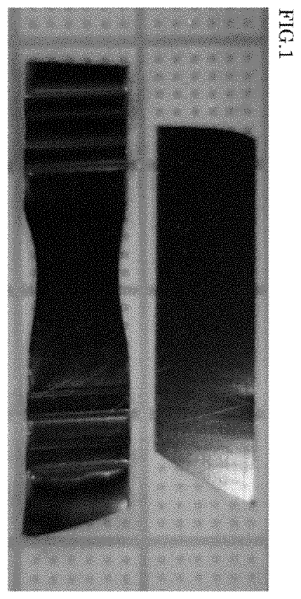

The fibrous carbon nanohorn aggregate is described in detail also in International Publication No. WO2016/147909. In FIG. 1 and FIG. 2 in International Publication No. WO2016/147909, transmission electron microscopic photographs of a fibrous carbon nanohorn aggregate are disclosed. In the fibrous carbon nanohorn aggregate shown in the transmission electron microscopic photographs, single-walled carbon nanohorns radially aggregated (carbon nanohorn aggregate) are fibrously connected. The entire disclosure of International Publication No. WO2016/147909 is incorporated in the present description by reference.

In a method for manufacturing the fibrous carbon nanohorn aggregate, carbon containing a catalyst is used as a target (called a catalyst-containing carbon target), and the catalyst-containing carbon target is heated by laser ablation in a nitrogen, inert, hydrogen, carbon dioxide or mixed atmosphere under rotation of the target in a chamber where the target is disposed, to thereby vaporize the target. In the course of the vaporized carbon and catalyst being cooled, the fibrous carbon nanohorn aggregate is obtained. Other than the above laser ablation method, an arc discharge method or resistance heating method can be used. However, the laser ablation method is more preferable from the viewpoint of being capable of continuous production at room temperature and at the atmospheric pressure.

The laser ablation method applied in the present invention is a method in which the target is irradiated with laser continuously or in pulses, and when the irradiation intensity reaches a value equal to or higher than a threshold, the target converts energy, resulting in production of plumes, and the product is guided to deposit on the substrate provided downstream of the target, or to be suspended in a space in the apparatus and recovered in the recovery room.

The laser ablation can use a CO₂ laser, a YAG laser, an excimer laser, a semiconductor laser or the like, and a CO₂ laser, which is easy in output raising, is most suitable. The CO₂ laser can be used at an output of 1 kW/cm² to 1,000 kW/cm², and can carry out continuous irradiation and pulsed irradiation. For production of the fibrous carbon nanohorn aggregate, the continuous irradiation is more desirable. Laser beams are condensed by a ZnSe lens or the like and irradiated. The aggregate can be synthesized continuously by rotating the target. The rotational speed of the target may be set optionally, but 0.1 rpm to 6 rpm is especially preferable. At 0.1 rpm or more, graphitization can be suppressed; and at 6 rpm or less, the increase of amorphous carbon can be suppressed. At the time, the laser output is preferably 15 kW/cm² or more, and most effectively 30 kW/cm² to 300 kW/cm². When the laser output is 15 kW/cm² or more, the target is suitably vaporized and the production of the fibrous carbon nanohorn aggregate is made easy. When the laser output is 300 kW/cm² or less, the increase of the amorphous carbon can be suppressed. The pressure in the chamber can be used at 13,332.2 hPa (10,000 Torr) or lower, but the closer to vacuum the pressure, the production of carbon nanotubes is made easier, resulting in making it difficult for the fibrous carbon nanohorn aggregate to be obtained. The pressure in the chamber is preferably 666.61 hPa (500 Torr) to 1,266.56 hPa (950 Torr), and more preferably nearly the atmospheric pressure (1,013 hPa (1 atm≅760 Torr), which is suitable also for mass synthesis and cost reduction. The irradiation area can be controlled by the laser output and the extent of light condensing by the lens, and 0.005 cm² to 1 cm² can be used.

With regard to the catalyst, Fe, Ni and Co can be used singly or as a mixture thereof. The concentration of the catalyst can suitably be selected, but is, with respect to carbon, preferably 0.1% by mass to 10% by mass and more preferably 0.5% by mass to 5% by mass. At a concentration of 0.1% by mass or more, the production of the fibrous carbon nanohorn aggregate is secured; and at a concentration of 10% by mass or less, the increase of the target cost can be suppressed.

The temperature in the chamber can be optional and is preferably 0° C. to 100° C. and more preferably room temperature, which is suitable also for mass synthesis and cost reduction.

By introducing nitrogen gas, inert gas, hydrogen gas, CO₂ gas or the like singly or as a mixture thereof in the chamber, the above atmosphere is made. From the viewpoint of the cost, nitrogen gas or Ar gas is preferable. The gas is circulated in the reaction chamber and produced substances can be recovered by the flow of the gas. The atmosphere gas flow rate can be optional, but is preferably suitable in the range of 0.5 L/min to 100 L/min. In the course of the target being vaporized, the gas flow rate is controlled at a constant rate.

The fibrous carbon nanohorn aggregates obtained as in the above are usually obtained together with spherical carbon nanohorn aggregates. Hereinafter, a mixture of the fibrous carbon nanohorn aggregate and the spherical carbon nanohorn aggregate is also called simply a carbon nanohorn aggregate. The spherical carbon nanohorn aggregate is a spherical carbon structural body in which single-walled carbon nanohorns are radially aggregated. The spherical carbon nanohorn aggregates have a diameter of about 30 nm to 200 nm, and have a nearly uniform size. In the obtained fibrous carbon nanohorn aggregate and spherical carbon nanohorn aggregate, part of their carbon skeleton may be substituted by a catalytic metal element, a nitrogen atom and the like. The fibrous carbon nanohorn aggregate may be used by being isolated. The fibrous carbon nanohorn aggregate may be used together with other carbon materials such as the spherical carbon nanohorn aggregate. The fibrous carbon nanohorn aggregate and the spherical carbon nanohorn aggregate can be separated according to the difference in their size. Further, if impurities other than the carbon nanohorn aggregate are contained, the impurities can be removed by centrifugation, or separation using the difference in the sedimentation rate or the size, or the like. By varying the producing condition, the ratio between the fibrous carbon nanohorn aggregates and the spherical carbon nanohorn aggregates can also be varied.

When fine holes are intended to be made (hole-opening) in the carbon nanohorn aggregate, the hole-opening can be carried out by an oxidizing treatment. The oxidizing treatment forms surface functional groups containing oxygen on open hole portions. For the oxidizing treatment, a gas-phase process and a liquid-phase process can be used. In the case of the gas-phase process, the treatment is carried out by a heat treatment in an atmosphere gas containing oxygen, such as air, oxygen or carbon dioxide. Among these, air is suitable from the viewpoint of the cost. The temperature may be in the range of 300° C. to 650° C., and 400° C. to 550° C. is more suitable. At a temperature of 300° C. or higher, carbon burns and open holes can securely be formed. At a temperature of 650° C. or lower, burning of the whole carbon nanohorn aggregate can be suppressed. In the case of the liquid-phase process, the treatment is carried out in a liquid containing an oxidative substance such as nitric acid, sulfuric acid or hydrogen peroxide. In the case of nitric acid, the liquid may be used in the temperature range of room temperature to 120° C. With the temperature being 120° C. or lower, no oxidation more than necessary occurs. In the case of hydrogen peroxide, the liquid may be used in the temperature range of room temperature to 100° C., and 40° C. or higher is more preferable. The oxidizing power efficiently acts in the temperature range of 40° C. to 100° C., and open holes can be formed efficiently. In the liquid-phase process, concurrent use of light irradiation is more effective.

The catalytic metal contained in production of, as required, can be removed. The catalytic metal can be removed since it is dissolved in nitric acid, sulfuric acid and hydrochloric acid. From the viewpoint of ease in use, hydrochloric acid is suitable. The temperature for dissolving the catalyst can suitably be selected, but when it is intended to sufficiently remove the catalyst, the resultant carbon nanohorn aggregate is desirably heated at 70° C. or higher. When nitric acid or sulfuric acid is used, the catalyst removal and the formation of open holes can be carried out simultaneously or continuously. Since there is a case where the catalyst is covered with a carbon film in production of the carbon nanohorn aggregate, in order to remove the carbon film, it is desirable to carry out a pre-treatment. The pre-treatment desirably involves heating in air at about 250° C. to 450° C. The some cases of 300° C. or higher form a part of open holes as described above.

The carbon nanohorn aggregate can be improved in crystallinity by being heat treated in a non-oxidative atmosphere such as inert gas, hydrogen or vacuum. The heat treatment temperature may be 800° C. to 2,000° C., but is preferably 1,000° C. to 1,500° C. After the hole-opening treatment, surface functional groups containing oxygen have been formed on open hole portions, but the functional groups can also be removed by a heat treatment. The heat treatment temperature may be 150° C. to 2,000° C. In order to remove carboxyl groups, hydroxyl groups and the like being the surface functional groups, 150° C. to 600° C. is desirable. In order to remove carbonyl groups being the surface functional group, 600° C. or higher is desirable. The surface functional group can be removed by being reduced in a gas or liquid atmosphere. For the reduction in a gas atmosphere, hydrogen can be used, and the treatment can also serve as the above treatment for improving crystallinity. In the liquid atmosphere, hydrazine or the like can be utilized.

The lower limit amount of the fibrous carbon nanohorn aggregate in the stretch-formed product is not especially limited, but is usually 0.1% by mass or more, preferably 0.3% by mass or more and more preferably 1% by mass or more. The upper limit amount of the fibrous carbon nanohorn aggregate in the stretch-formed product is not especially limited, but is usually 50% by mass or less, preferably 20% by mass or less and more preferably 5% by mass or less. By making the fibrous carbon nanohorn aggregate to be contained, the stretch-formed product results in having a high conductivity. The fibrous carbon nanohorn aggregate is excellent in dispersibility as compared with other carbon materials such as carbon nanotubes. Hence, without adding a surfactant to raise the dispersibility to the stretch-formed product, the conductivity can be improved.

The resin to be used for the stretch-formed product is not especially limited, but a thermoplastic resin is preferable. Examples of the thermoplastic resin include polyolefin such as polyethylene, polypropylene, polybutadiene and cyclic olefin copolymers, polystyrene, polyphenylene ether, polycarbonate, polyurethane, polyamide, polyacetal, polyesters such as polyethylene terephthalate, polybutylene terephthalate and polybutylene succinate, polyvinyl chloride, polyetherimide, polysulfone, polyphenylene sulfone, and copolymers and mixtures thereof. The lower limit amount of the resin in the stretch-formed product is usually 40% by mass or more, and preferably 50% by mass or more. The upper limit amount of the resin in the stretch-formed product is usually 99% by mass or less and preferably 95% by mass or less, and may also be 80% by mass or less. In an amount of less than 40% by mass, the effect of improving the mechanical property by stretching may not be sufficiently exhibited. On the other hand, in an amount of more than 99% by mass, a high conductivity may not be imparted to the stretch-formed product.

The stretch-formed product, as required, may further contain additives. The additives are not especially limited, and examples thereof include leveling agents, dyes, pigments, dispersants, ultraviolet absorbents, antioxidants, light-resistant stabilizers, metal deactivators, peroxide decomposing agents, fillers, reinforcing agents, plasticizers, thickeners, lubricants, anticorrosives, emulsifiers, flame retardants and anti-dripping agents.

The stretch-formed product may contain, together with the fibrous carbon nanohorn aggregate, other conductive materials. Examples of the other conductive materials include carbon materials such as carbon nanotubes, spherical carbon nanohorn aggregates and graphite, as well as metals and alloys such as tin, tin-indium, tin-silver, tin-gold, tin-zinc, gold, silver, platinum, iridium and tungsten. The total amount of the conductive materials in the stretch-formed product is not especially limited, but is usually 1% by mass or more, preferably 5% by mass or more and more preferably 8% by mass or more. The total amount of the conductive materials in the stretch-formed product is not especially limited, but is usually 50% by mass or less, preferably 30% by mass or less and more preferably 15% by mass or less.

The stretch-formed product according to the present embodiment can be used in a desired shape such as fiber or film. These can be produced by stretching an unstretch-formed product. A stretching method to be used may be any conventionally known stretching method, and examples thereof include rolling, and uniaxial stretching. The stretching temperature may suitably be determined according to the melting point and the glass transition point of the resin to be used. The stretching can be carried out by heating the unstretch-formed product in a range of temperatures equal to or higher than the glass transition point of the resin and equal to or lower than the melting point thereof, for example, at a temperature higher by about 5% to 30% of the range than the glass transition point (unit: ° C.). In the early period of the stretching, the stretching temperature is allowed to be a higher temperature, and the unstretch-formed product can be heated at a temperature higher by about 30% to 80% of the range than the glass transition point (unit: ° C.). The stretch ratio differs depending on the stretching temperature, the shape and size of the unstretch-formed product, the shape and size of the target stretch-formed product, and the like. 1.1 times or more stretch ratio for the stretch-formed product, especially, 2 times or more is preferable because of giving the stretch-formed product excellent in the mechanical strength and the like. The stretch ratio for the stretch-formed product is usually 10 times or less. The stretch ratio can be calculated by the expression: (a length after stretching)/(a length before the stretching). In the stretch-formed product, at least part (for example, with respect to the total amount of the fibrous carbon nanohorn aggregates contained in the stretch-formed product, 20% by mass or more, especially, 30% by mass or more, and for example, 60% by mass or less) of the fibrous carbon nanohorn aggregates are arrayed in the same direction. This is due to stretching, and there is made a state that the fibrous carbon nanohorn aggregates are extended along the stretch direction. Thereby, conductive paths are formed.

In one embodiment, the stretch-formed product is formed of a resin composition, and the resin composition comprises the fibrous carbon nanohorn aggregate. The resin composition can be formed by mixing the resin and the fibrous carbon nanohorn aggregate. The stretch-formed product is obtained by stretching the obtained resin composition.

In one embodiment, the stretch-formed product has a plurality of layers, and at least one layer thereof is a conductive layer comprising the fibrous carbon nanohorn aggregate. The conductive layer may be formed only of the fibrous carbon nanohorn aggregate and other carbon materials, but usually further contains a resin and is formed of a resin composition. In the case of a film, a plurality of layers can be formed by laminating a resin layer and a conductive layer containing the fibrous carbon nanohorn aggregate. In the case of a fiber, a plurality of layers can be formed by simultaneously spinning a resin and a resin composition containing the fibrous carbon nanohorn aggregate. In the case of a multi-fiber used in optogenetics, a resin composition containing the fibrous carbon nanohorn aggregate is formed into a rod shape to form a conductive layer. A plurality of layers can be formed by covering the obtained conductive layer with a resin sheet. A plurality of layers can also be formed by inserting a resin composition containing the fibrous carbon nanohorn aggregate into a resin formed into a cylinder shape. Besides, a plurality of layers can be formed by dip coating, spray coating or the like.

### EXAMPLES

In Examples, the evaluation was made by using three kinds of nanocarbon materials of a fibrous carbon nanohorn aggregate (CNB), a spherical carbon nanohorn aggregate (CNHs) and a carbon nanotube (CNT). CNB and CNHs used were prepared as follows. CNT used was a commercially available product (manufactured by Meijo Nano Carbon Co., Ltd.).

### (Preparation of the Nanocarbon Materials)

CO₂ laser was condensed by a ZnSe lens and a target in an acryl chamber was irradiated therewith. For manufacture of CNHs, there was used a target having a bulk density of 1.66 Mg/m³, a hardness of 57HSD and a thermal conductivity of 44 W/m·K. For manufacture of CNB, there was used a target having an iron content of 3 atomic %, a bulk density of 1.44 Mg/m³, a hardness of 61HSD and a thermal conductivity of 20 W/m·K. After the each target was vaporized by the CO₂ laser, a product depositing in the chamber was recovered. At this time, the chamber atmosphere was at room temperature and at a pressure of 760 Torr. An atmosphere gas used was N₂, and the flow rate was controlled at 10 L/min. The CO₂ laser was operated in the continuous wave mode. The laser output was 3,200 W and the target was rotated at 1.5 rpm.

### (Preparation of Evaluation Samples)

Polybutylene succinate (PBS) dissolved in chloroform and the nanocarbon material were stirred for 15 min to homogeneously disperse the nanocarbon material. Thereafter, chloroform was evaporated on a hot plate at 90° C. to thereby obtain a resin composition in which the nanocarbon material was homogeneously dispersed in PBS. Here, three resin compositions were prepared which were a resin composition (CNB-PBS) using CNB as the nanocarbon material, a resin composition (CNHs-PBS) using CNHs as the nanocarbon material, and a resin composition (CNT-PBS) using the carbon nanotube as the nanocarbon material. The amount of the nanocarbon material in each resin composition was made to be 9% by mass. The each obtained resin composition was heated to 200° C., and pressed at a pressure of 130 kg/cm². Thereafter, the resultant was cooled to room temperature under the pressure to thereby obtain a film having a uniform thickness. The film was cut out into a strip film of 8 mm in width, which was taken as an evaluation sample before stretching. Then, the strip film was stretched, and taken as an evaluation sample after stretching. The films before stretching and after stretching are shown in FIG. 1. The stretch ratio for the stretched film was about 1.3 times.

### (Measurement of the Electric Resistance)

The measurement of the electric resistance was carried out by using a semiconductor parameter analyzer (manufactured by Agilient Technologies, Inc., 4155C) and attaching terminals to the one evaluation sample and using the four-terminal method. The measurement results of the resistivity are shown in Table 1. CNB-PBS retained a high conductivity even after stretching. By contrast, CNHs-PBS after stretching increased the resistance value to 90,000 Ωcm, which was a resistance near that of an insulator. It has been made clear that as compared with CNHs having a spherical structure, CNB having a fibrous structure effectively functioned to the conductivity after stretching. CNT was scarcely mixed with PBS since it was low in dispersibility, and the resulting sample had a very high resistance, making it difficult to evaluate.

TABLE 1

| | before stretching | after stretching |
|---|---|---|
| Sample | (Ω cm) | (Ω cm) |
| CNB-PBS | 10 | 3000 |
| CNHs-PBS | 2000 | 90000 |
| CNT-PBS | Measurement could | Measurement could |
| | not be performed. | not be performed. |

This application is based upon and claims the benefit of priority from Japanese patent application No.2019-007685, filed on Jan. 21, 2019, the disclosure of which is incorporated herein in its entirety.

While the invention has been described with reference to example embodiments and examples thereof, the invention is not limited to the above example embodiments and examples. Various changes that can be understood by those skilled in the art may be made to the configuration and details of the invention within the scope of the present invention.

What is claimed is:

1. A stretch-formed product, comprising:
a fibrous carbon nanohorn aggregate in which single-walled carbon nanohorns are radially aggregated and fibrously connected and
a resin.

2. The stretch-formed product according to claim 1, wherein the resin is selected from the group consisting of polyolefin, polystyrene, polyphenylene ether, polycarbonate, polyurethane, polyamide, polyacetal, polyester, polyvinyl chloride, polyetherimide and polysulfone.

3. The stretch-formed product according to claim 1, wherein an amount of the resin is 40% by mass or more and 95% by mass or less.

4. The stretch-formed product according to claim 1, wherein the stretch-formed product is a fiber or a film.

5. A method for producing a stretch-formed product according to claim 1, the method comprising the steps of:
mixing a fibrous carbon nanohorn aggregate in which single-walled carbon nanohorns are radially aggregated and fibrously connected, with a resin to thereby prepare a resin composition; and
stretching the resin composition.
